(19) United States
(12) Patent Application Publication
(10) Pub. No.: US 2016/0376425 A1
(43) Pub. Date: Dec. 29, 2016

(54) COMPOUND COMPOSITION FOR COATED YARN HAVING PORES

(71) Applicant: Heedae Park, Busan (KR)

(72) Inventor: Heedae Park, Busan (KR)

(21) Appl. No.: 15/262,505

(22) Filed: Sep. 12, 2016

Related U.S. Application Data
(63) Continuation of application No. PCT/KR2014/006236, filed on Jul. 11, 2014.

(30) Foreign Application Priority Data
Mar. 18, 2014 (KR) 10-2014-0031418

(51) Int. Cl. C08K 7/28; D06M 15/564; C09D 175/04; C08K 7/22; C09D 7/12

(52) U.S. Cl. CPC C08K 7/28; C08K 7/22; C09D 7/1216; C09D 7/1233; C09D 175/04; D06M 15/564; D06M 2101/32

(57) ABSTRACT

The present invention discloses a compound composition for coated yarn having pores that enables the manufacture of a coated yarn with reduced weight in relation to general coted yarns by adding a filler having pores, preferably glass bubble, acryl bubble, etc., to a thermoplastic polyurethane resin and then applying a coating of the mixture to a yarn in order to form a light coated yarn having a specific gravity of 1.0 or less.

### REFERENCE TO RELATED APPLICATIONS

This is a continuation of pending International Patent Application PCT/KR2014/006236 filed on Jul. 11, 2014, which designates the United States and claims priority of Korean Patent Application No. 10-2014-0031418 filed on Mar. 18, 2014, the entire contents of which are incorporated herein by reference.

### FIELD OF THE INVENTION

The present invention relates to a compound composition for coated yarn having pores and, more particularly, to a compound composition for coated yarn having pores that can form pores in the coated yarn to reduce the weight of the coated yarn by adding a filler having pores to a thermoplastic polyurethane resin (or polyurethane resin) and then applying a coating of the mixture to the yarn.

### BACKGROUND OF THE INVENTION

As well known in the related art, the yarns used to make fabric materials for industrial applications or footwear are chiefly made of polyester, nylon, acryl, or the like.

The fabric materials made of such yarns are poor in durability and wear resistance and much problematic in regards to adhesion or the like, so they have too many limitations to be available for functional uses such as footwear fabric materials, etc.

Further, there has been a sustained demand for development of softer yarns for better “hand” feel of the parts that are frequently in contact with the human body. Hence, many attempts have been continuously made to solve the problem by using a thermoplastic polyurethane resin.

However, the manufacture of a yarn using a thermoplastic polyurethane resin by the same method of making polyester or nylon yarns requires a high processing cost and involves practical difficulties in making a thermoplastic polyurethane yarn due to the viscosity and tackiness of the thermoplastic polyurethane resin.

A conventional solution to this problem is coating the surface of a polyester, nylon or acryl yarn with PVC or PP; or making an at least 1,000 denier thermoplastic polyurethane yarn as disclosed in the following patent documents 1, 2 and 3.

Disadvantageously, such coated yarns (more specifically, coated polyester, nylon or acryl yarns) are poor in durability, wear resistance and other properties such as mechanical and chemical strengths.

Further, as mentioned above, the patent documents 1, 2 and 3 disclose yarns having a thickness of 1,000 denier or greater, which yarns are unavailable for use in fabric materials for footwear due to their stiffness.

Moreover, the patent document 5 leads to deterioration of productivity with low viscosity when using a thermoplastic polyurethane resin, makes it impossible to form a thin coated yarn and causes the surface of the coated yarn glossy, thus requiring a separate delustering process.

On the other hand, the inventors of the present invention have proposed patent documents 6 and 7 in order to solve the above-mentioned problems with the conventional coated yarns. The patent documents 6 and 7 definitely provide an invention useful to manufacture a coated yarn excellent in durability and wear resistance and enhanced in mechanical and chemical strengths, and particularly a coated yarn having a fineness of 250 denier or less.

The patent documents 6 and 7 may enable the manufacture of a thin coated yarn but cannot realize a coated yarn having low thickness and light weight as well. For this reason, the present invention is to provide a compound composition for coated yarn that makes it possible to form a coated yarn with low coating thickness and light weight at the same time.

### PRIOR ART

### Patent Documents

Patent Document 1: KR Laid-open Patent Publication No. 10-2011-0069868 (under the title of “Woven Fabric Including Elastic Polyurethane Thread” as filed on Jun. 23, 2011)

Patent Document 2: KR Registered Patent Publication No. 10-0875709 (under the title of “Non-Slip Fabric Using Thermoplastic Polyurethane Coated Yarn” as filed on Dec. 23, 2008)

Patent Document 3: KR Registered Patent Publication No. 10-0193110 (under the title of “Device for Drawing Off Polyurethane Coated Yarn Using Twisted Thread” as filed on Feb. 2, 1997)

Patent Document 4: KR Laid-Open Patent Publication No. 10-2012-0078630 (under the title of “Polyester Yarn and Fabrication Method thereof” as filed on Jul. 10, 2012)

Patent Document 5: KR Registered Patent Publication No. 10-0875709 (under the title of “Non-Slip Fabric Using Thermoplastic Polyurethane Coated Yarn” as filed on Dec. 23, 2008)

Patent Document 6: KR Registered Patent Publication No. 10-1318135 (under the title of “Thermoplastic Polyurethane Compound Composition for Coated Yarn” as filed on Jul. 10, 2013)

Patent Document 7: KR Registered Patent Publication No. 10-1341055 (under the title of “Composition for Thermoplastic Polyurethane Yarn and Preparation Method thereof” as filed on Dec. 13, 2013)

### SUMMARY OF THE INVENTION

It is an object of the present invention to provide a compound composition for coated yarn having pores that forms pores in a coated yarn to reduce the weight of the coated yarn by adding a filler having pores to a thermoplastic polyurethane resin (or polyurethane resin) and then forming a coating layer on a yarn according to the co-extrusion or dipping coating method.

For achieving the object of the present invention, there is provided a compound composition for coated yarn as used to make a coated yarn that comprises a thermoplastic polyurethane resin or a polyurethane resin and a filler having pores, preferably any one selected from glass bubble or acryl bubble.

More preferably, the filler having pores is used in an amount of about 3 to 25 wt. % with respect to the polyurethane.

### BRIEF DESCRIPTION OF THE DRAWINGS

FIG. 1 is an image showing the cross-section of a coated yarn fabricated from a compound composition for coated yarn having pores according to one preferred embodiment of the present invention; and

FIG. 2 is an image showing the cross-section of a general coated yarn.

### DETAILED DESCRIPTION OF THE INVENTION

A compound composition for coated yarn that is used to make a coated yarn according to the present invention is comprised of any one composition selected from a thermoplastic polyurethane resin or a polyurethane resin, and a filler having pores.

Hereinafter, the embodiments of the present invention will be described with reference to the accompanying drawings. In the following detailed description, representative examples of the present invention will be given in order to achieve the above-described technical solutions. And, other embodiments that the present invention may provide are substituted by the detailed description of the present invention.

The present invention is to realize a compound composition for coated yarn having pores that enables the manufacture of a coated yarn with reduced weight in relation to the general coated yarns by adding a filler having pores (preferably, glass bubble or acryl bubble) to a thermoplastic polyurethane resin and then applying a coating of the mixture to a yarn in order to make a light coated yarn having a specific gravity of 1.0 or less.

The present invention may fabricate a coated yarn by adding a filler having pores to a thermoplastic polyurethane resin and then applying any coating method, such as melting the resin mixture in an extruder and applying a coating of the melted mixture to a yarn; or dipping a yarn into the resin mixture to form a coating layer on the yarn.

In this regard, the present invention proposes mixing a filler having pores with a thermoplastic polyurethane resin. But, the present invention may also include adding the filler having pores to a polyurethane-based resin and then applying a coating of the mixture to the yarn.

In addition, the term “yarn” as used in the present invention refers to a general yarn and may include any kind of yarn commercially available, such as polyester yarn, nylon yarn, acryl yarn, etc.

The technical concept to be realized in the present invention is the weight reduction of the coated yarn. To achieve this object of the present invention, the present invention uses a filler having pores, preferably glass bubble or acryl bubble in the form of fine beads.

For the best effects of the present invention, the present invention preferably adds a filler having pores in an amount of 3 to 25 wt. % with respect to the weight of the thermoplastic polyurethane resin (or polyurethane resin). When the content of the filler having pores is greater than 25 wt. %, it deteriorates the coating workability and thus results in lots of incomplete coatings.

Hereinafter, a description will be given as to the compound composition for coated yarn having pores according to one preferred embodiment of the present invention with reference to the tables 1 and 2.

The following table presents a comparison of physical properties between a general coated yarn and a coated yarn of the present invention made by adding glass bubble as a filler having pores to a resin and then applying a coating of the mixture to a yarn. In the table 1, a comparison is made in regards to the physical properties for the three types of coated yarn: (1) comprising 75 wt. % of thermoplastic polyurethane and 25 wt. % of glass bubble; (2) comprising 83 wt. % of thermoplastic polyurethane and 17 wt. % of glass bubble; and (3) comprising 87 wt. % of thermoplastic polyurethane and 13 wt. % of glass bubble.

TABLE 1

| | | | General | 25 wt. % | 17 wt. % | 13 wt. % | |
|---|---|---|---|---|---|---|---|
| | | | coated | of glass | of glass | of glass | |
| Item | | Unit | yarn | bubble | bubble | bubble | Standards |
| Yarn | Type | | PET | PET | PET | PET | |
| | Color | | White | White | White | White | |
| | Thickness | Denier | 250 ± 20 | 250 ± 20 | 250 ± 20 | 250 ± 20 | ASTM1577 |
| Coated | Color | | White | White | White | White | |
| yarn | Thickness | Denier | 950 ± 50 | 950 ± 50 | 950 ± 50 | 950 ± 50 | ASTMD1577 |
| | Yarn | % | 25 ± 5 | 25 ± 5 | 25 ± 5 | 25 ± 5 | |
| | content | | | | | | |
| | Specific | g/cc | 1.01 ± 0.01 | 0.83 ± 0.01 | 0.85 ± 0.01 | 0.90 ± 0.01 | |
| | gravity | | | | | | |
| | Tensile | Kg | 1.82 | 1.85 | 1.67 | 1.79 | ASTMD885 |
| | strength | | | | | | |
| | Elongation | % | 10.5 | 11.8 | 11.2 | 12.7 | ASTMD885 |

As can be seen from Table 1, glass bubble is used as the filler having pores and its content is at most 25 wt. %. In this case, when the content of the glass bubble is greater than 25 wt. %, the processability is noticeably decreased to cause incomplete coating or exfoliation of the coating, leading to problems in the work.

It is therefore apparent in the present invention that using about 20 wt. % of the glass bubble can reduce the specific gravity of the coated yarn by about 20% in relation to the conventional coated yarn. Further, there is a tendency that the tensile strength decreases with an increase in the content of the glass bubble.

On the other hand, the following table 2 presents a comparison of physical properties between a general coated yarn and a coated yarn of the present invention made by adding acryl bubble as a filler having pores to a resin and then applying a coating of the mixture to a yarn. In the table 2, a comparison is made in regards to the physical properties for the three types of coated yarn: (1) comprising 90 wt. % of thermoplastic polyurethane and 10 wt. % of acryl bubble; (2) comprising 95 wt. % of thermoplastic polyurethane and 5 wt. % of acryl bubble; and (3) comprising 97 wt. % of thermoplastic polyurethane and 3 wt. % of acryl bubble.

TABLE 2

| | | | General | 10 wt. % | 5 wt. % | 3 wt. % | |
|---|---|---|---|---|---|---|---|
| | | | coated | of acryl | of acryl | of glass | |
| Item | | Unit | yarn | bubble | bubble | bubble | Standards |
| Yarn | Type | | PET | PET | PET | PET | |
| | Color | | White | White | White | White | |
| | Thickness | Denier | 250 ± 20 | 250 ± 20 | 250 ± 20 | 250 ± 20 | ASTM1577 |
| Coated | Color | | White | White | White | White | |
| yarn | Thickness | Denier | 950 ± 50 | 950 ± 50 | 950 ± 50 | 950 ± 50 | ASTMD1577 |
| | Yarn | % | 25 ± 5 | 25 ± 5 | 25 ± 5 | 25 ± 5 | |
| | content | | | | | | |
| | Specific | g/cc | 1.01 ± 0.01 | 0.80 ± 0.01 | 0.85 ± 0.01 | 0.90 ± 0.01 | |
| | gravity | | | | | | |
| | Tensile | Kg | 1.82 | 1.22 | 1.35 | 1.55 | ASTMD885 |
| | strength | | | | | | |
| | Elongation | % | 10.5 | 9.2 | 9.8 | 10.3 | ASTMD885 |

As can be seen from Table 2, acryl bubble is used as the filler having pores and its content is at most 10 wt. %. In this regard, when the content of the acryl bubble is greater than 10 wt. %, the processability is noticeably decreased to cause incomplete coating or exfoliation of the coating in a consistent manner, leading to problems in the work.

It is therefore apparent in the present invention that the use of 10 wt. % of the acryl bubble can reduce the specific gravity of the coated yarn by about 20% in relation to the conventional coated yarn. In using the acryl glass, the tensile strength tends to be a little lower than when using the glass bubble.

As described above, the present invention, using a filler having pores (preferably, glass bubble or acryl bubble), can reduce the weight of the coated yarn by about 20% in relation to the conventional coated yarn. This fact is demonstrated in Tables 1 and 2.

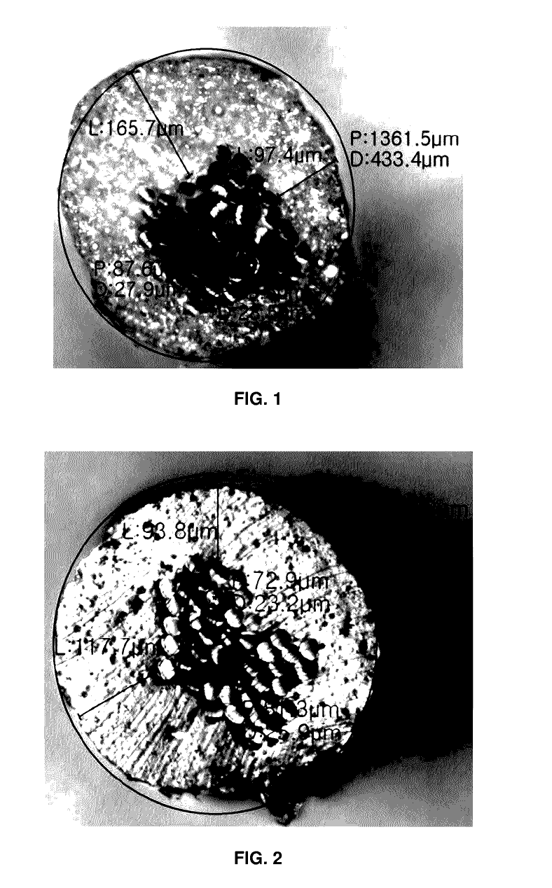

FIG. 1 is an image showing the cross-section of a coated yarn fabricated from a compound composition for coated yarn having pores according to the present invention; and FIG. 2 is an image showing the cross-section of a general coated yarn. Referring to FIGS. 1 and 2, the general coated yarn has a dense structure, while the coated yarn of the present invention contains lots of pores in the resin that surrounds the yarn, thereby reducing the weight of the coated yarn. In this regard, FIG. 1 is an image showing the cross-section of the coated yarn using 25 wt. % of glass bubble.

The present invention uses glass bubble or acryl bubble added to a thermoplastic polyurethane resin or a polyurethane resin in the manufacture of a coating yarn to form pores in the coated yarn, as shown in FIG. 1, and thus to reduce the weight of the coated yarn. More specifically, the present invention can advantageously reduce the weight of the coated yarn by at most about 20% in relation to the conventional coated yarn.

1. A compound composition for coated yarn having pores, which compound composition is used to manufacture a coated yarn, the compound composition comprising:
any one composition selected from a thermoplastic polyurethane resin or a polyurethane resin; and
a filler having pores.

2. The compound composition for coated yarn having pores as claimed in claim 1, wherein the filler having pores is glass bubble or acryl bubble.

3. The compound composition for coated yarn having pores as claimed in claim 1 or 2, wherein the compound composition comprises 75 to 97 wt. % of any one composition selected from a thermoplastic polyurethane resin or a polyurethane resin; and 3 to 25 wt. % of the filler having pores.
